(19) United States
(12) Patent Application Publication
(10) Pub. No.: US 2026/0088577 A1
(43) Pub. Date: Mar. 26, 2026

(54) CONNECTOR AND CONNECTOR ASSEMBLY

(71) Applicant: SUMITOMO WIRING SYSTEMS, LTD., Mie (JP)

(72) Inventor: Ryohei TSUTSUI, Mie (JP)

(21) Appl. No.: 19/111,277

(22) PCT Filed: Sep. 14, 2023
(86) PCT No.: PCT/JP2023/033582

§ 371 Date: Mar. 12, 2025

(30) Foreign Application Priority Data
Sep. 20, 2022 (JP) 2022-149160

(51) Int. Cl. H01R 13/74

(52) U.S. Cl. CPC H01R 13/743

(57) ABSTRACT

A connector includes a connector housing to be fixed to a lamp body having a fixing hole penetrating the lamp body along a first axis. The connector housing includes: a body portion capable of passing through the fixing hole; a flange portion extending from the body portion outward in a direction intersecting the first axis; a seating surface provided on the flange portion and capable of abutting against the lamp body along the first axis; an elastic locking piece extending from the seating surface along the first axis and capable of being locked to the lamp body; and a protective wall provided adjacent to the elastic locking piece to protect the elastic locking piece. The protective wall has a rotation preventing rib protruding in a direction intersecting the first axis to prevent the connector housing from rotating about the first axis relative to the lamp body.

### TECHNICAL FIELD

The present disclosure relates to a connector and a connector assembly.

### BACKGROUND

Conventionally, there is a connector assembly in which a connector constituting the connector assembly is fixed to a fixing member having a fixing hole (see, for example, Patent Document 1). A connector housing of such a connector has a tubular body portion that passes through the fixing hole and an elastic locking portion that can be locked to the fixing member.

### PRIOR ART DOCUMENT

### Patent Document

Patent Document 1: JP 2010-102872 A

### SUMMARY OF THE INVENTION

### Problems to be Solved

Incidentally, for example, when a waterproofing rubber ring is provided around the connector housing so as to be pressed against an inner wall surface of the fixing hole, the waterproofing performance of the rubber ring will deteriorate if the connector housing rotates around an axis along the penetrating direction of the fixing hole, relative to the fixing member. In such cases, it is necessary to firmly suppress rotation of the connector relative to the fixing member.

An object of the present disclosure is to provide a connector and a connector assembly that can suitably suppress the rotation of the connector relative to the fixing member.

### Means to Solve the Problem

A connector of the present disclosure is a connector including a connector housing configured to be fixed to a fixing member having a fixing hole penetrating the fixing member along a first axis, the connector housing including: a body portion configured to pass through the fixing hole; a flange portion extending from the body portion outward in a direction intersecting the first axis; a seating surface provided on the flange portion and configured to abut against the fixing member along the first axis; an elastic locking piece extending from the seating surface along the first axis and configured to be locked to the fixing member; and a protective wall provided adjacent to the elastic locking piece and configured to protect the elastic locking piece, wherein the protective wall has a rotation preventing rib protruding in a direction intersecting the first axis and configured to prevent the connector housing from rotating about the first axis relative to the fixing member.

A connector assembly of the present disclosure is a connector assembly including: a connector including a connector housing configured to be fixed to a fixing member having a fixing hole penetrating the fixing member along a first axis; and a retrofit connector including a retrofit connector housing configured to be fitted to the connector housing fixed to the fixing member, the connector housing including: a body portion configured to pass through the fixing hole; a flange portion extending from the body portion outward in a direction intersecting the first axis; a seating surface provided on the flange portion and configured to abut against the fixing member along the first axis; an elastic locking piece extending from the seating surface along the first axis and configured to be locked to the fixing member; and a protective wall provided adjacent to the elastic locking piece and configured to protect the elastic locking piece, wherein the protective wall has a rotation preventing rib protruding in a direction intersecting the first axis and configured to prevent the connector housing from rotating about the first axis relative to the fixing member, and the retrofit connector housing includes a deformation restricting portion configured to be inserted between the elastic locking piece locked to the fixing member and the body portion to restrict elastic deformation of the elastic locking piece.

### Effect of the Invention

According to the connector and the connector assembly of the present disclosure, rotation of the connector relative to the fixing member can be suitably suppressed.

### BRIEF DESCRIPTION OF THE DRAWINGS

FIG. 1 is a perspective view of a lamp body and a connector assembly in one embodiment.

FIG. 2 is an exploded perspective view of the lamp body and a connector in one embodiment.

FIG. 3 is a front view of the lamp body and the connector in one embodiment.

FIG. 4 is a sectional view taken along line 4-4 in FIG. 3.

FIG. 5 is a perspective view of the connector in one embodiment.

FIG. 6 is a partially enlarged plan view of the connector in one embodiment.

FIG. 7 is a partially enlarged perspective view of the connector in one embodiment.

FIG. 8 is a sectional view taken along line 8-8 in FIG. 3.

### DETAILED DESCRIPTION TO EXECUTE THE INVENTION

### Description of Embodiments of the Present Disclosure

First, embodiments of the present disclosure will be listed and described.
[1] A connector of the present disclosure is a connector including a connector housing configured to be fixed to a fixing member having a fixing hole penetrating the fixing member along a first axis, the connector housing including: a body portion configured to pass through the fixing hole; a flange portion extending from the body portion outward in a direction intersecting the first axis; a seating surface provided on the flange portion and configured to abut against the fixing member along the first axis; an elastic locking piece extending from the seating surface along the first axis and configured to be locked to the fixing member; and a protective wall provided adjacent to the elastic locking piece and configured to protect the elastic locking piece, wherein the protective wall has a rotation preventing rib protruding in a direction intersecting the first axis and configured to prevent the connector housing from rotating about the first axis relative to the fixing member.

According to this configuration, since the connector housing includes a protective wall provided adjacent to the elastic locking piece to protect the elastic locking piece, for example, application of unintended large force to the elastic locking piece is suppressed in a state before the connector housing is fixed to the fixing member. Therefore, for example, damage to the elastic locking piece is suppressed. In addition, since the protective wall has the rotation preventing rib protruding in a direction intersecting the first axis to prevent the connector housing from rotating about the first axis relative to the fixing member, the connector is prevented from rotating about the first axis relative to the fixing member. Since the rotation preventing rib is provided on the protective wall, the structure of the connector housing can be simplified compared to, for example, a case where the rotation preventing rib is provided separately at a site different from the protective wall. In other words, the protective wall having the rotation preventing rib functions to protect the elastic locking piece in the state before the connector housing is fixed to the fixing member, and functions to prevent the connector from rotating while the connector housing is fixed to the fixing member.
[2] In the above [1], a pair of the protective walls may be provided on opposite sides of the elastic locking piece.

According to this configuration, since the pair of protective walls are provided on opposite sides of the elastic locking piece, application of unintended large force to the elastic locking piece is further suppressed. Therefore, for example, damage to the elastic locking piece is further suppressed.
[3] In the above [1] or [2], the rotation preventing rib may be provided at a position close to the seating surface in a direction along the first axis.

According to this configuration, since the rotation preventing rib is provided at a position close to the seating surface in the direction along the first axis, it is possible to suppress sliding contact of the rotation preventing rib with the fixing member more than necessary in an initial stage of inserting the body portion into the fixing hole. Therefore, for example, assembly performance of inserting the body portion into the fixing hole is improved. In addition, for example, wear of the rotation preventing rib can be suppressed. Therefore, in a final stage when the seating surface abuts against the fixing member, the rotation preventing rib can be brought into good contact with the fixing member, and the connector housing can be well prevented from rotating about the first axis relative to the fixing member.
[4] In any one of the above [1] to [3], the rotation preventing rib may have an inclined surface whose protrusion amount increases while extending from an end of the rotation preventing rib farther from the seating surface toward the seating surface.

According to this configuration, since the rotation preventing rib has an inclined surface whose protrusion amount increases while extending from an end of the rotation preventing rib farther from the seating surface toward the seating surface, assembly by inserting the body portion into the fixing hole is made smooth.
[5] In any one of the above [1] to [4], the body portion may have a rectangular outer shape when viewed from a direction along the first axis, and the elastic locking piece and the protective wall may be provided at positions shifted from a center in a longitudinal direction of the body portion when viewed from the direction along the first axis.

According to this configuration, since the elastic locking piece and the protective wall are provided at positions shifted from the center in the longitudinal direction of the body portion when viewed from the direction along the first axis, the connector is further prevented from rotating about the first axis relative to the fixing member. That is, for example, even if backlash is reduced at a center position in the longitudinal direction of the body portion, the backlash increases at positions shifted from the center in the longitudinal direction of the body portion. In contrast, since the elastic locking piece and the protective wall are provided at positions shifted from the center in the longitudinal direction of the body portion, the backlash at the positions shifted from the center in the longitudinal direction of the body portion can be reduced, and thus the connector is further prevented from rotating.
[6] In any one of the above [1] to [5], a rubber ring configured to come into pressure contact with an inner wall surface of the fixing hole may be fitted around the flange portion.

According to this configuration, since the rubber ring capable of coming into pressure contact with the inner wall surface of the fixing hole is fitted around the flange portion, the region is made waterproof. Then, in such a connector, if the connector rotates around the first axis, there is a possibility that the force of pressure contact with the inner wall surface of the fixing hole is partially weakened, resulting in deterioration in waterproof properties of the rubber ring, however, this can be avoided, and thus the waterproof properties can be maintained well.
[7] A connector assembly of the present disclosure is a connector assembly including: a connector including a connector housing configured to be fixed to a fixing member having a fixing hole penetrating the fixing member along a first axis; and a retrofit connector including a retrofit connector housing configured to be fitted to the connector housing fixed to the fixing member, the connector housing including: a body portion configured to pass through the fixing hole; a flange portion extending from the body portion outward in a direction intersecting the first axis; a seating surface provided on the flange portion and configured to abut against the fixing member along the first axis; an elastic locking piece extending from the seating surface along the first axis and configured to be locked to the fixing member; and a protective wall provided adjacent to the elastic locking piece and configured to protect the elastic locking piece, wherein the protective wall has a rotation preventing rib protruding in a direction intersecting the first axis and configured to prevent the connector housing from rotating about the first axis relative to the fixing member, and the retrofit connector housing includes a deformation restricting portion configured to be inserted between the elastic locking piece locked to the fixing member and the body portion to restrict elastic deformation of the elastic locking piece.

According to this configuration, since the connector housing includes the protective wall provided adjacent to the elastic locking piece to protect the elastic locking piece, for example, application of unintended large force to the elastic locking piece is suppressed in the state before the connector housing is fixed to the fixing member. Therefore, for example, damage to the elastic locking piece is suppressed. In addition, since the protective wall has the rotation preventing rib protruding in a direction intersecting the first axis to prevent the connector housing from rotating about the first axis relative to the fixing member, the connector is prevented from rotating about the first axis relative to the fixing member. Since the rotation preventing rib is provided on the protective wall, the structure of the connector housing can be simplified compared to, for example, the case where the rotation preventing rib is provided separately at a site different from the protective wall. In other words, the protective wall having the rotation preventing rib functions to protect the elastic locking piece in the state before the connector housing is fixed to the fixing member, and functions to prevent the connector from rotating while the connector housing is fixed to the fixing member. In addition, since the retrofit connector housing includes the deformation restricting portion that is inserted between the elastic locking piece locked to the fixing member and the body portion to restrict elastic deformation of the elastic locking piece, release of a state in which the elastic locking piece is locked to the fixing member is suppressed. Therefore, removal of the connector from the fixing member is suppressed.

### Details of Embodiments of the Present Disclosure

Specific examples of connector assembly according to the present disclosure are described below with reference to the drawings. In the drawings, some configurations may be exaggerated or simplified for convenience of explanation. Dimensional ratios of portions may differ between the drawings. In this specification, “parallel”, “orthogonal”, and “perfect circle” do not only mean strictly parallel, orthogonal, or true circle, but also include approximately parallel, orthogonal, or true circular within a range that achieves operational effects of the present embodiment. Note that the present invention is not limited to these examples, but is defined by the claims, and is intended to include all modifications within the meaning and scope of equivalency of the claims.

### (Configuration of Connector Assembly 11)

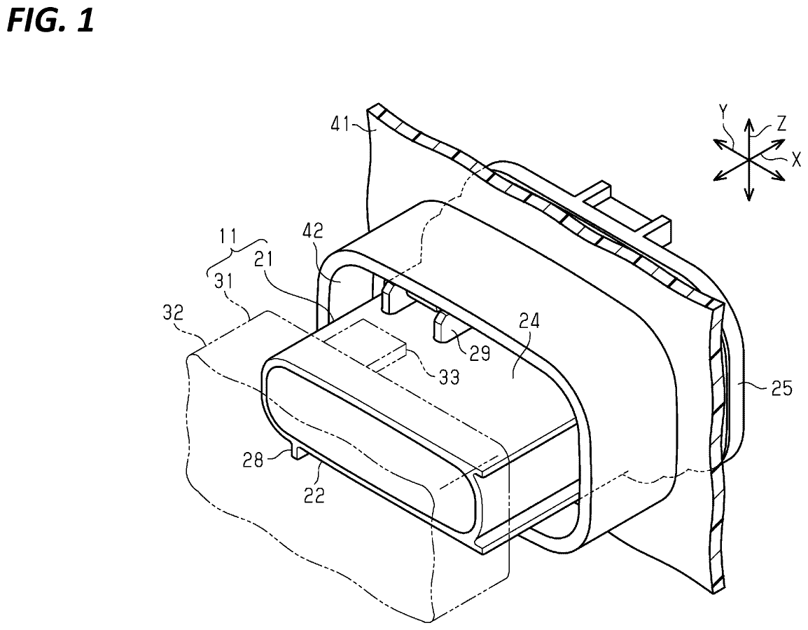

As illustrated in FIG. 1, a connector assembly 11 includes a connector 21 and a retrofit connector 31 connected to the connector 21. The connector assembly 11 is for connecting, for example, a lamp (not illustrated) provided in a vehicle to an electric wire. The connector 21 in the present embodiment is connected to the lamp and fixed to a lamp body 41 serving as a fixing member. The retrofit connector 31 is connected to the electric wire and fitted to the connector 21 fixed to the lamp body 41. Note that the figure illustrates a first axis X, a second axis Y orthogonal to the first axis X, and a third axis Z orthogonal to the first axis X and the second axis Y. In the present embodiment, the direction along the first axis X may be referred to as the penetration direction or the depth direction, the direction along the second axis Y may be referred to as the width direction, and the direction along the third axis Z may be referred to as the height direction.

### (Configuration of Lamp Body 41)

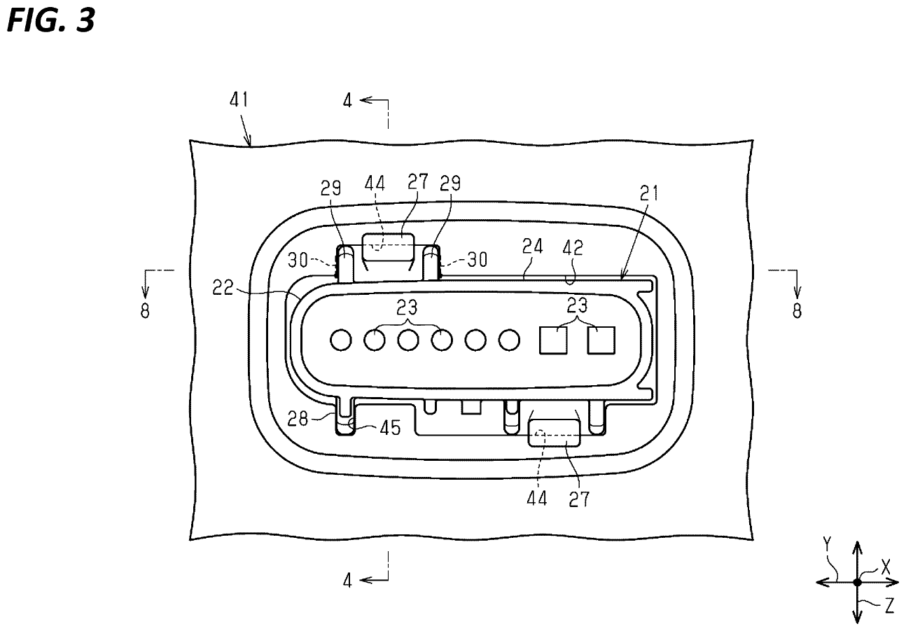

As illustrated in FIGS. 1 to 4, the lamp body 41 has a fixing hole 42 that penetrates along the first axis X. As illustrated in FIG. 3, the fixing hole 42 has a rectangular shape when viewed from the direction along the first axis X. Note that in the present embodiment, when viewed from the direction along the first axis X, the longitudinal direction of the fixing hole 42 is the direction along the second axis Y, which is the width direction, and the short direction of the fixing hole 42 is the direction along the third axis Z, which is the height direction. The fixing hole 42 has a locking portion 44, a positioning groove 45, and the like on a part of an inner wall surface 43 thereof.

### (Configuration of Connector 21)

As illustrated in FIG. 3, the connector 21 has a connector housing 22 and a plurality of terminals 23 held in the connector housing 22. The connector housing 22 is made of a resin material.

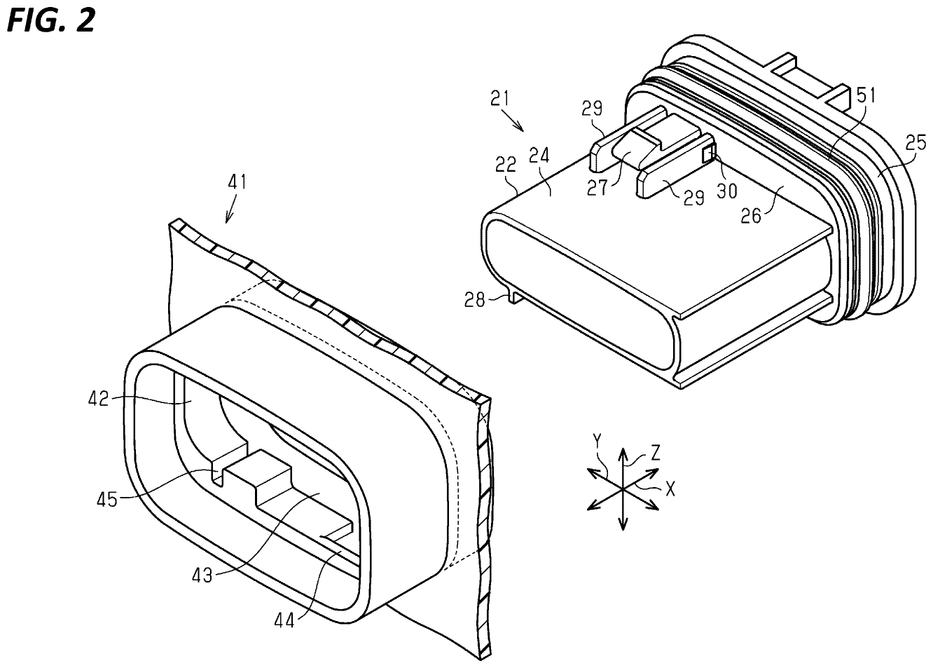

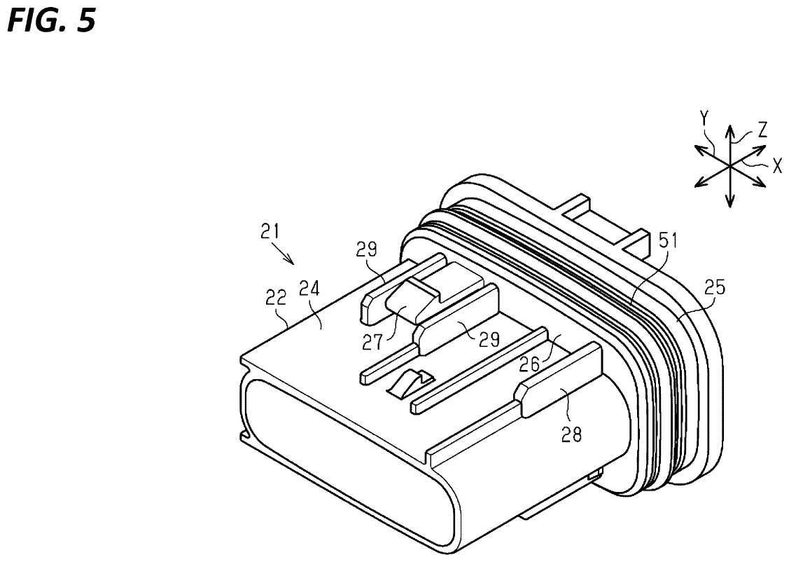

As illustrated in FIGS. 2 and 5, the connector housing 22 includes a body portion 24, a flange portion 25, a seating surface 26, elastic locking pieces 27, a positioning protrusion 28, and a protective wall 29. The body portion 24 is capable of passing through the fixing hole 42, and is fixed to the lamp body 41 while passing through the fixing hole 42. As illustrated in FIG. 3, the body portion 24 has a rectangular outer shape when viewed from the direction along the first axis X. The body portion 24 has a rectangular tube shape and holds the plurality of terminals 23 therein. Note that the plurality of terminals 23 in the present embodiment are arranged side by side in the longitudinal direction of the body portion 24 when viewed from the direction along the first axis X.

The flange portion 25 extends outward from an outer periphery of the body portion 24 in a direction intersecting the first axis X. A rubber ring 51 capable of coming into pressure contact with the inner wall surface 43 of the fixing hole 42 is fitted around the flange portion 25.

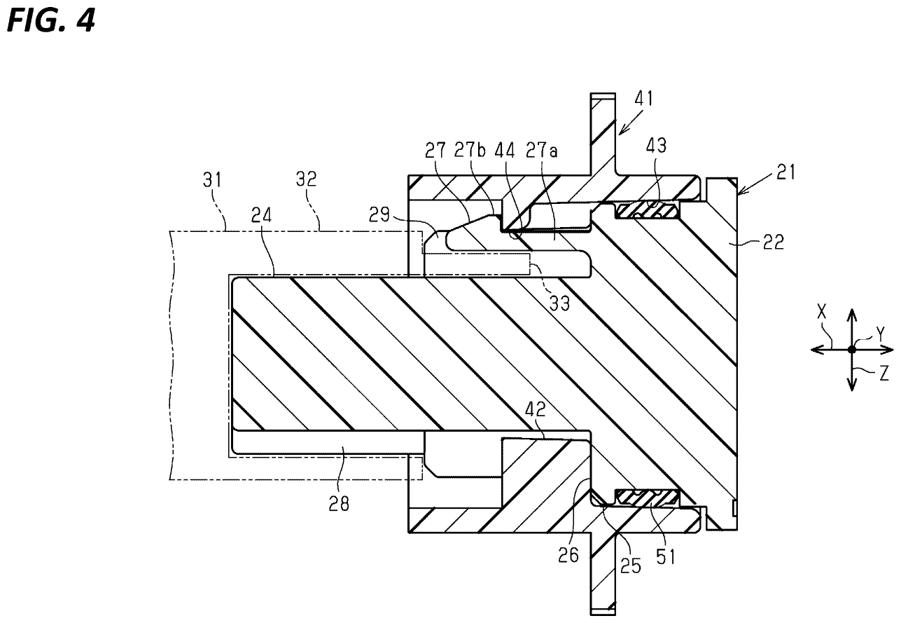

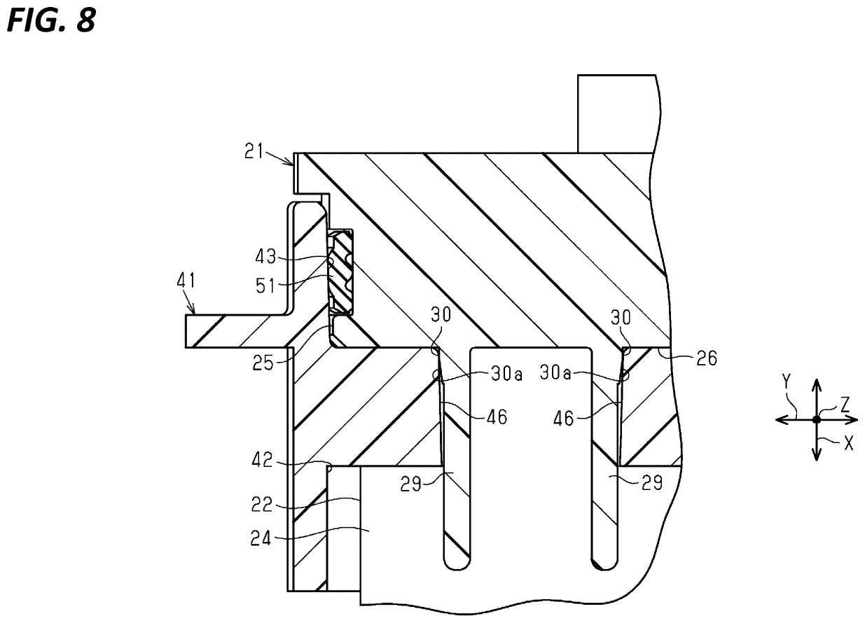

As illustrated in FIGS. 4 and 8, since the rubber ring 51 comes into pressure contact with the inner wall surface 43 of the fixing hole 42 while the connector housing 22 is fixed to the lamp body 41, the region is made waterproof. Note that FIG. 4 schematically illustrates the inside of the connector housing 22, with the terminals 23 and the like omitted.

The seating surface 26 is provided on the flange portion 25 and is a surface capable of abutting against the lamp body 41 along the first axis X. That is, the seating surface 26 is a surface orthogonal to the first axis X on the flange portion 25 extending outward from the outer periphery of the body portion 24, and abuts against the lamp body 41 in the direction along the first axis X while the connector housing 22 is fixed to the lamp body 41.

As illustrated in FIGS. 2 and 4, each of the elastic locking pieces 27 extends from the seating surface 26 along the first axis X and is capable of being locked to the lamp body 41.

In more detail, as illustrated in FIG. 4, the elastic locking piece 27 has an extension portion 27a extending from the seating surface 26 along the first axis X while having a gap with the body portion 24, and a claw portion 27b protruding from a tip of the extension portion 27a in a direction away from the body portion 24. The extension portion 27a of the elastic locking piece 27 is elastically deformable. When the body portion 24 is inserted into the fixing hole 42, the extension portion 27a of the elastic locking piece 27 elastically deforms, and when the seating surface 26 abuts against the lamp body 41, elastic deformation of the extension portion 27a is released, and thus the claw portion 27b is locked to the locking portion 44 of the lamp body 41.

As illustrated in FIG. 3, the elastic locking piece 27 is provided at a position shifted from a center in the longitudinal direction of the body portion 24 when viewed from the direction along the first axis X. In other words, the elastic locking piece 27 is provided at a position shifted from the center of the body portion 24 in the width direction along the second axis Y. Further, the elastic locking piece 27 is provided on both sides in the short direction of the body portion 24 when viewed from the direction along the first axis X. In other words, two elastic locking pieces 27 are provided in the height direction along the third axis Z. Also, the two elastic locking pieces 27 in the height direction are provided at positions shifted in opposite directions from the center in the longitudinal direction of the body portion 24.

The positioning protrusion 28 stands upright from a part of the body portion 24. The positioning protrusion 28 is provided, when viewed from the direction along the first axis X, at a position shifted from the center in the longitudinal direction of the body portion 24, on the side where the elastic locking piece 27 is not provided. The positioning protrusion 28 is provided only on one side in the short direction of the body portion 24 when viewed from the direction along the first axis X. The positioning protrusion 28 fits into the positioning groove 45 of the lamp body 41 when the body portion 24 is inserted into the fixing hole 42, thereby preventing incorrect assembly.

The protective walls 29 are provided adjacent to the elastic locking piece 27 to protect the elastic locking piece 27. Two protective walls 29 are provided on opposite sides of the elastic locking piece 27. The protective walls 29 stand upright from the body portion 24 so as to cover sides in the width direction of the extension portion 27a of the elastic locking piece 27. The protective walls 29 extend from the seating surface 26 to a position beyond the tip of the elastic locking piece 27 in the direction along the first axis X. The protective walls 29 suppress application of an unintended large force to the elastic locking piece 27 in a state before the connector housing 22 is fixed to the lamp body 41.

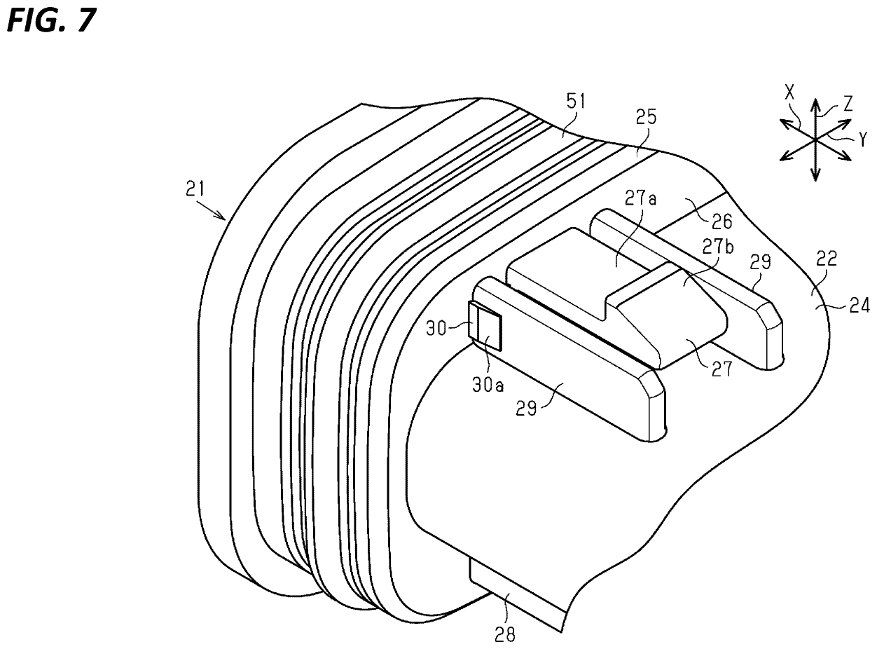

As illustrated in FIGS. 2, 6, 7, and 8, each of the protective walls 29 has a rotation preventing rib 30. The rotation preventing rib 30 protrudes in a direction intersecting the first axis X to prevent the connector housing 22 from rotating about the first axis X relative to the lamp body 41.

The rotation preventing ribs 30 in the present embodiment are provided on the protective walls 29 provided adjacent to one of the two elastic locking pieces 27. More specifically, the rotation preventing ribs 30 are provided on the protective walls 29 on the side where the positioning protrusion 28 is not provided in the height direction along the third axis Z.

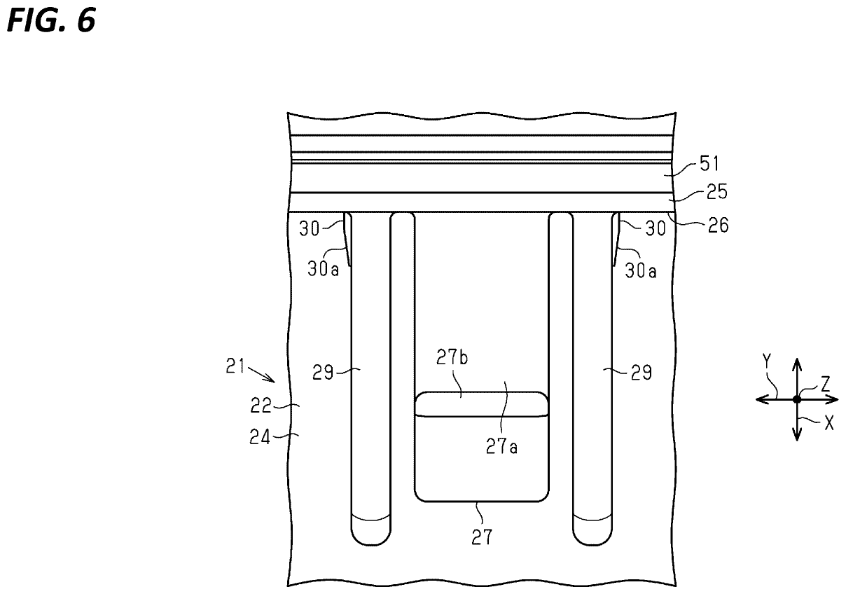

As illustrated in FIG. 6, the rotation preventing ribs 30 protrude in directions away from each other and in the width direction along the second axis Y from the pair of protective walls 29 provided on opposite sides of the elastic locking piece 27.

The rotation preventing ribs 30 are each provided at position close to the seating surface 26 in the direction along the first axis X. The rotation preventing ribs 30 in the present embodiment are part of the protective walls 29 in the direction along the first axis X, and are provided at positions continuous with the seating surface 26. Each of the rotation preventing ribs 30 has an inclined surface 30a whose protrusion amount increases while extending from the end of the rotation preventing rib 30 farther from the seating surface 26 toward the seating surface 26.

As illustrated in FIG. 8, in the lamp body 41, a pair of contact surfaces 46 facing each other, with which the pair of rotation preventing ribs 30 come into contact, are formed such that the distance between them is slightly wider toward the seating surface 26. That is, the pair of contact surfaces 46 are draft tapered surfaces having a distance slightly wider toward the direction in which the mold is removed during manufacturing.

The rotation preventing ribs 30 are in contact with the contact surfaces 46 while the connector housing 22 is fixed to the lamp body 41, thereby preventing the connector housing 22 from rotating about the first axis X relative to the lamp body 41. In other words, the rotation preventing ribs 30 prevent backlash of the connector housing 22 in the direction of rotation about the first axis X relative to the lamp body 41.

### (Configuration of Retrofit Connector 31)

As illustrated in FIGS. 1 and 4, the retrofit connector 31 has a retrofit connector housing 32 and a plurality of terminals (not illustrated) held in the retrofit connector housing 32. The retrofit connector housing 32 is made of a resin material.

The retrofit connector housing 32 can be fitted to the connector housing 22 fixed to the lamp body 41. The terminals of the retrofit connector 31 are connected to the terminals 23 of the connector 21 while the retrofit connector housing 32 is fitted to the connector housing 22.

As illustrated in FIG. 4, the retrofit connector housing 32 has a deformation restricting portion 33. The deformation restricting portion 33 is inserted between one elastic locking piece 27 locked to the lamp body 41 and the body portion 24 while the retrofit connector housing 32 is fitted to the connector housing 22, thereby restricting elastic deformation of the elastic locking piece 27.

Next, operation of the connector assembly 11 configured as described above will be described.

When the body portion 24 of the connector housing 22 is inserted into the fixing hole 42 of the lamp body 41 along the first axis X, the seating surface 26 provided on the flange portion 25 abuts against the lamp body 41. Then, the elastic locking pieces 27 are locked to the lamp body 41, and thus the connector 21 is fixed to the lamp body 41.

When the retrofit connector housing 32 is fitted to the connector housing 22, the terminals of the retrofit connector 31 are connected to the terminals 23 of the connector 21, and the deformation restricting portion 33 is inserted between one elastic locking piece 27 and the body portion 24. Therefore, the elastic deformation of the elastic locking piece 27 is restricted, and removal of the connector 21 from the lamp body 41 is suppressed.

Next, effects of the above embodiment will be described below.
(1) The connector housing 22 has the protective wall 29 provided adjacent to the elastic locking piece 27 to protect the elastic locking piece 27. Therefore, for example, application of unintended large force to the elastic locking piece 27 is suppressed in the state before the connector housing 22 is fixed to the lamp body 41. Therefore, for example, damage to the elastic locking piece 27 is suppressed.

The protective wall 29 has the rotation preventing rib 30 protruding in the direction intersecting the first axis X to prevent the connector housing 22 from rotating about the first axis X relative to the lamp body 41. Therefore, the connector 21 is prevented from rotating about the first axis X relative to the lamp body 41. Since the rotation preventing rib 30 is provided on the protective wall 29, the structure of the connector housing 22 can be simplified compared to, for example, a case where the rotation preventing rib 30 is provided separately at a site different from the protective wall 29. In other words, the protective wall 29 having the rotation preventing rib 30 functions to protect the elastic locking piece 27 in the state before the connector housing 22 is fixed to the lamp body 41. The protective wall 29 having the rotation preventing rib 30 also functions to prevent the connector 21 from rotating while the connector housing 22 is fixed to the lamp body 41.
(2) Since the pair of protective walls 29 are provided on opposite sides of the elastic locking piece 27, application of unintended large force to the elastic locking piece 27 is further suppressed. Therefore, for example, damage to the elastic locking piece 27 is further suppressed.
(3) Since the rotation preventing rib 30 is provided at a position close to the seating surface 26 in the direction along the first axis X, it is possible to suppress sliding contact of the rotation preventing rib 30 with the lamp body 41 more than necessary in the initial stage of inserting the body portion 24 into the fixing hole 42. Therefore, for example, assembly performance of inserting the body portion 24 into the fixing hole 42 is improved. In addition, for example, wear of the rotation preventing rib 30 can be suppressed. Therefore, in a final stage when the seating surface 26 abuts against the lamp body 41, the rotation preventing rib 30 can be brought into good contact with the contact surface 46 of the lamp body 41, and the connector housing 22 can be well prevented from rotating about the first axis X relative to the lamp body 41.
(4) Since the rotation preventing rib 30 has an inclined surface 30a whose protrusion amount increases while extending from an end of the rotation preventing rib 30 farther from the seating surface 26 toward the seating surface 26, assembly by inserting the body portion 24 into the fixing hole 42 is made smooth.
(5) Since the elastic locking piece 27 and the protective wall 29 are provided at positions shifted from the center in the longitudinal direction of the body portion 24 when viewed from the direction along the first axis X, the connector 21 is prevented from rotating around the first axis X relative to the lamp body 41. That is, for example, even if backlash is reduced at a center position in the longitudinal direction of the body portion 24, the backlash increases at positions shifted from the center in the longitudinal direction of the body portion 24. In contrast, since the elastic locking piece 27 and the protective wall 29 are provided at positions shifted from the center in the longitudinal direction of the body portion 24, the backlash at the positions shifted from the center in the longitudinal direction of the body portion 24 can be reduced, and thus the connector 21 is further prevented from rotating.
(6) Since the rubber ring 51 capable of coming into pressure contact with the inner wall surface 43 of the fixing hole 42 is fitted around the flange portion 25, the region is made waterproof. Then, in such a connector 21, if the connector 21 rotates around the first axis X, there is a possibility that the force of pressure contact with the inner wall surface 43 of the fixing hole 42 is partially weakened, resulting in deterioration in waterproof properties of the rubber ring 51, however, this can be avoided, and thus the waterproof properties can be maintained well.
(7) The retrofit connector housing 32 includes the deformation restricting portion 33 that is inserted between the elastic locking piece 27 locked to the lamp body 41 and the body portion 24 to restrict elastic deformation of the elastic locking piece 27. Therefore, release of a state in which the elastic locking piece 27 is locked to the lamp body 41 is suppressed. Therefore, the removal of the connector 21 from the lamp body 41 is suppressed.

The present embodiment can be implemented with modifications such as the following. The present embodiment and the following modifications can be implemented in combination as long as there is no technical contradiction.
In the above embodiment, the pair of protective walls 29 are provided on opposite sides of the elastic locking piece 27, but are not limited thereto, and it is possible to, for example, provide the protective wall on only one side of the elastic locking piece 27. That is, the rotation preventing rib 30 together with the protective wall 29 may be provided on only one side of the elastic locking piece 27.
In the above embodiment, the rotation preventing rib 30 is provided at a position close to the seating surface 26 in the direction along the first axis X of the protective wall 29, but is not limited thereto, and may, for example, extend over the entire protective wall 29 in the direction along the first axis X. Further, in the above embodiment, the rotation preventing rib 30 is provided at a position continuous with the seating surface 26, but is not limited thereto and may not be continuous with the seating surface 26.
In the above embodiment, the rotation preventing rib 30 has the inclined surface 30a whose protrusion amount increases while extending from the end of the rotation preventing rib 30 farther from the seating surface 26 toward the seating surface 26, but is not limited thereto, and may not have the inclined surface 30a.
In the above embodiment, the elastic locking piece 27 and the protective wall 29 are provided at positions shifted from the center in the longitudinal direction of the body portion 24, but are not limited thereto. For example, either the elastic locking piece 27 or the protective wall 29 may be provided at the center position in the longitudinal direction of the body portion 24.
In the above embodiment, the rubber ring 51 capable of coming into pressure contact with the inner wall surface 43 of the fixing hole 42 is fitted around the flange portion 25, but is not limited thereto, and for example, a water stop member having a different structure may be provided at another site.
In the above embodiment, the retrofit connector housing 32 includes the deformation restricting portion 33 that restricts elastic deformation of the elastic locking piece 27, but is not limited thereto, and may be configured not to include the deformation restricting portion 33.
In the above embodiment, the rotation preventing rib 30 is provided on the protective wall 29 provided adjacent to one of the two elastic locking pieces 27, but is not limited thereto, and may be provided, for example, on all of the protective walls 29.
In the above embodiment, the connector housing 22 includes the two elastic locking pieces 27, but is not limited thereto, and may be configured to include, for example, only one elastic locking piece 27 or three or more elastic locking pieces 27.
In the above embodiment, the fixing member to which the connector housing 22 is fixed is the lamp body 41, but is not limited thereto, and may be embodied as a fixing member other than the lamp body 41.
The protective wall 29 may be configured to allow the elastic locking piece 27 to elastically deform an amount greater than or equal to a first elastic deformation amount sufficient to be locked to the lamp body 41, and to prevent the elastic locking piece 27 from elastically deforming an amount greater than or equal to a second elastic deformation amount at which the elastic locking piece 27 can be damaged. For example, when the elastic locking piece 27 is in a non-elastically deformed state or in a natural state in which it is not elastically deformed, an elastic deformation allowable space may be defined between the protective wall 29 and the elastic locking piece 27. For example, in an example illustrated in FIG. 6, when the elastic locking piece 27 is in the non-elastically deformed state or in the natural state in which it is not elastically deformed, each of the two protective walls 29 does not have to come into contact with the elastic locking piece 27, and for example, the elastic deformation allowable space may be defined between each protective wall 29 and the elastic locking piece 27 in the direction along the second axis Y (in the width direction of the elastic locking piece 27).
The protective wall 29 may be configured to cooperate with the seating surface 26a to prevent the extension portion 27a of the elastic locking piece 27 excluding the claw portion 27b from coming into direct contact with non-connector elements other than the connector 21. For example, to obtain this operation, one or more or all of relative positions between the seating surface 26a, the protective wall 29, and a base end of the elastic locking piece 27, a shape of the protective wall 29, and a size of the protective wall 29 may be adjusted, selected, or determined.

### LIST OF REFERENCE NUMERALS

11 Connector assembly
21 Connector
22 Connector housing
23 Terminal
24 Body portion
25 Flange portion
26 Seating surface
27 Elastic locking piece
27a Extension portion
27b Claw portion
28 Positioning protrusion
29 Protective wall
30 Rotation preventing rib
30a Inclined surface
31 Retrofit connector
32 Retrofit connector housing
33 Deformation restricting portion
41 Lamp body (Fixing member)
42 Fixing hole
43 Inner wall surface
44 Locking portion
45 Positioning groove
46 Contact surface
51 Rubber ring
X First axis
Y Second axis
Z Third axis

1. A connector comprising a connector housing configured to be fixed to a fixing member having a fixing hole penetrating the fixing member along a first axis,
the connector housing including:
a body portion configured to pass through the fixing hole;
a flange portion extending from the body portion outward in a direction intersecting the first axis;
a seating surface provided on the flange portion and configured to abut against the fixing member along the first axis;
an elastic locking piece extending from the seating surface along the first axis and configured to be locked to the fixing member; and
a protective wall provided adjacent to the elastic locking piece and configured to protect the elastic locking piece,
wherein the protective wall has a rotation preventing rib protruding in a direction intersecting the first axis and configured to prevent the connector housing from rotating about the first axis relative to the fixing member.

2. The connector according to claim 1, wherein a pair of the protective walls are provided on opposite sides of the elastic locking piece.

3. The connector according to claim 1, wherein the rotation preventing rib is provided at a position close to the seating surface in a direction along the first

4. The connector according to claim 1, wherein the rotation preventing rib has an inclined surface whose protrusion amount increases while extending from an end of the rotation preventing rib farther from the seating surface toward the seating surface.

5. The connector according to claim 1, wherein
the body portion has a rectangular outer shape when viewed from a direction along the first axis, and
the elastic locking piece and the protective wall are provided at positions shifted from a center in a longitudinal direction of the body portion when viewed from the direction along the first axis.

6. The connector according to claim 1, wherein a rubber ring configured to come into pressure contact with an inner wall surface of the fixing hole is fitted around the flange portion.

7. A connector assembly comprising:
a connector including a connector housing configured to be fixed to a fixing member having a fixing hole penetrating the fixing member along a first axis; and
a retrofit connector including a retrofit connector housing configured to be fitted to the connector housing fixed to the fixing member,
the connector housing including:
a body portion configured to pass through the fixing hole;
a flange portion extending from the body portion outward in a direction intersecting the first axis;
a seating surface provided on the flange portion and configured to abut against the fixing member along the first axis;
an elastic locking piece extending from the seating surface along the first axis and configured to be locked to the fixing member; and
a protective wall provided adjacent to the elastic locking piece and configured to protect the elastic locking piece,
wherein the protective wall has a rotation preventing rib protruding in a direction intersecting the first axis and configured to prevent the connector housing from rotating about the first axis relative to the fixing member, and
the retrofit connector housing includes a deformation restricting portion configured to be inserted between the elastic locking piece locked to the fixing member and the body portion to restrict elastic deformation of the elastic locking piece.
